(19) United States
(12) Patent Application Publication
(10) Pub. No.: US 2006/0085738 A1
(43) Pub. Date: Apr. 20, 2006

(54) Method and system for automatic audit trail

(76) Inventors: Frederic Chapus, Parkland, FL (US); Stephen N. Hord, Seattle, WA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/216,076

(22) Filed: Sep. 1, 2005

Related U.S. Application Data
(60) Provisional application No. 60/606,164, filed on Sep. 1, 2004.

(51) Int. Cl. G06F 17/21; G06F 17/24; G07F 19/00

(52) U.S. Cl. 715/513; 705/30; 715/503

(57) ABSTRACT

An exemplary method for tracking changes to a first electronic document containing financial data includes authenticating the first electronic document, receiving changes to the first electronic document and authorship information regarding the changes, creating a second electronic document that includes the financial data and the changes and identifies the changes, and repeating the authenticating, receiving, and creating. The second electronic document can be XBRL-compliant, and describe the financial data and the changes via XBRL. One or both of the first and second documents can include a digital signature, the second document can be stored in a secure archive accessible by an authentication service, and the authentication service can verify the first document based on the second document, which can be a non-repudiation document.

This application claims priority to U.S. Provisional Application No. 60/606,164 filed on 1 Sep. 2004.

### BACKGROUND INFORMATION

There are more than 30 million companies world wide. Many of them, including companies publicly listed world wide, use accounting and/or ERP (Enterprise Resource Planning) software, for example QuickBooks.

In the following paragraph, the substance of an exemplary balance sheet is shown, which can for example be displayed in a spreadsheet such as Microsoft Excel: A majority of accountants and clerks in charge of creating corporate financial reports, export data from the financial reports produced by their accounting and/or ERP software into spreadsheets like Microsoft Excel (in the U.S. it is estimated that such practice is used by approximately 95% of accountants).

Rock Castle Construction
Balance Sheet (December 31, 2003)

ASSETS

Current Assets

Checking/Savings

| | |
|---|---|
| Checking | −8,416.35 |
| Savings | 14,368.42 |

| | |
|---|---|
| Total Checking/Savings | 5,952.07 |
| Accounts Receivable | |

| | |
|---|---|
| Accounts Receivable | 79,320.45 |

| | |
|---|---|
| Total Accounts Receivable | 79,320.45 |
| Other Current Assets | |

| | |
|---|---|
| Tools & Equipment | 5,000.00 |
| Inventory Asset | 23,522.64 |
| Retainage | 2,461.80 |
| Un-deposited Funds | 36,982.34 |

| | |
|---|---|
| Total Other Current Assets | 67,996.78 |

| | |
|---|---|
| Total Current Assets | 153,239.30 |

Amendments or adjustments to the financial data are often performed before the data (including amendments for adjustments) is extracted from the spreadsheet and inserted into the company's final Financial Report (e.g. for submission to the Securities and Exchange Commission). For example, the separate entries of “Checking” and “Savings” in the example above can be combined into a single entry “Checking/Savings”.

Stock exchange regulators, bank regulators, insurance regulators, credit insurance companies, and also accounting firms, analysts and investors, world wide, have expressed concerns regarding the creation of financial reports as described above. This processing does not allow auditing of the source of the reported financial data. Sarbanes-Oxley legislation requires an audit trail function in the financial tools (including spreadsheets) used by the reporting companies. The need to export financial data into a spreadsheet before inserting the data into a final financial report is understood, but Federal regulators have imposed requirements for an automatic authenticated audit trail of any amendments/adjustments made to the financial data after it has been exported from the accounting/ERP software into the spreadsheet software.

### SUMMARY

An exemplary method for tracking changes to a first electronic document containing financial data includes authenticating the first electronic document, receiving changes to the first electronic document and authorship information regarding the changes, and creating a second electronic document that includes the financial data and the changes and identifies the changes. In an exemplary embodiment, the authenticating, receiving, and creating are repeated. The second electronic document can be XBRL-compliant, and describe the financial data and the changes via XBRL. One or both of the first and second documents can include a digital signature, the second document can be stored in a secure archive accessible by an authentication service, and the authentication service can verify the first document based on the second document, which can be a non-repudiation document.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and

FIG. 1 illustrates an exemplary method.

FIG. 2 illustrates exemplary changes to a financial document.

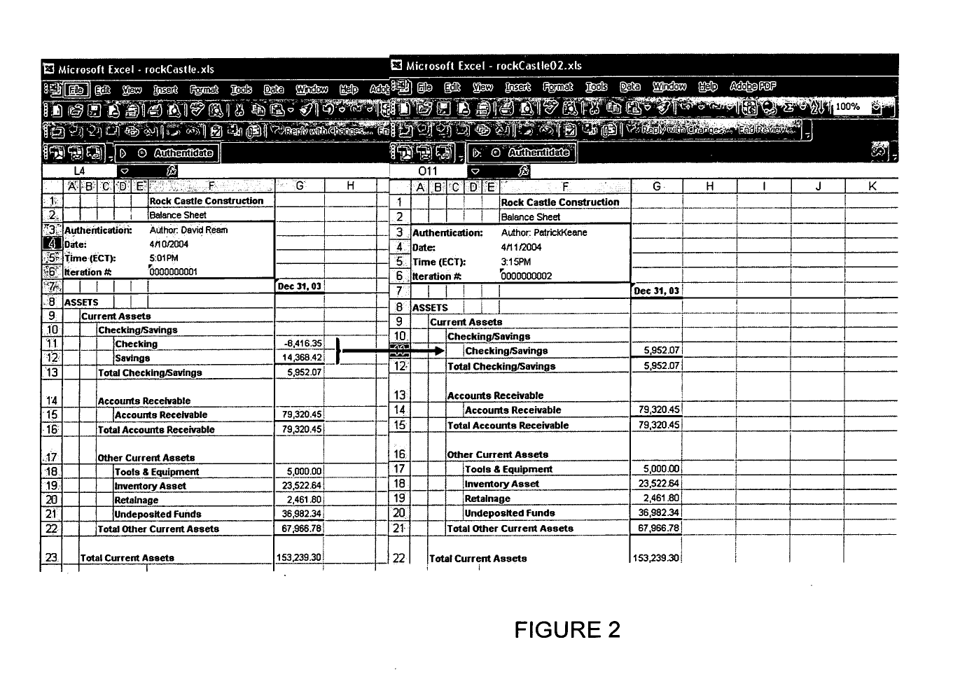

### DETAILED DESCRIPTION

Exemplary methods for creating an Automatic Audit Trail of documents, including for example electronic spreadsheets such as Microsoft Excel and other electronic documents such as word processing files (e.g. Microsoft Word documents), using XBRL (extensible Business Reporting Language) or any appropriate Standard for Web based services, are presented herein.

Exemplary methods and embodiments described herein provide solutions that can be operational on a world wide basis, to generate an automatic authenticated audit trail of any amendments/adjustments made to financial data after it has been exported from accounting/ERP software into spreadsheet software.

In an exemplary embodiment, modifications made to spreadsheets and text or word processing documents are tracked, for example by an Automatic Audit Trail software application, using XBRL or any appropriate Standard in connection with an Authentication Web based service. The software application can thus provide an automatic audit trail.

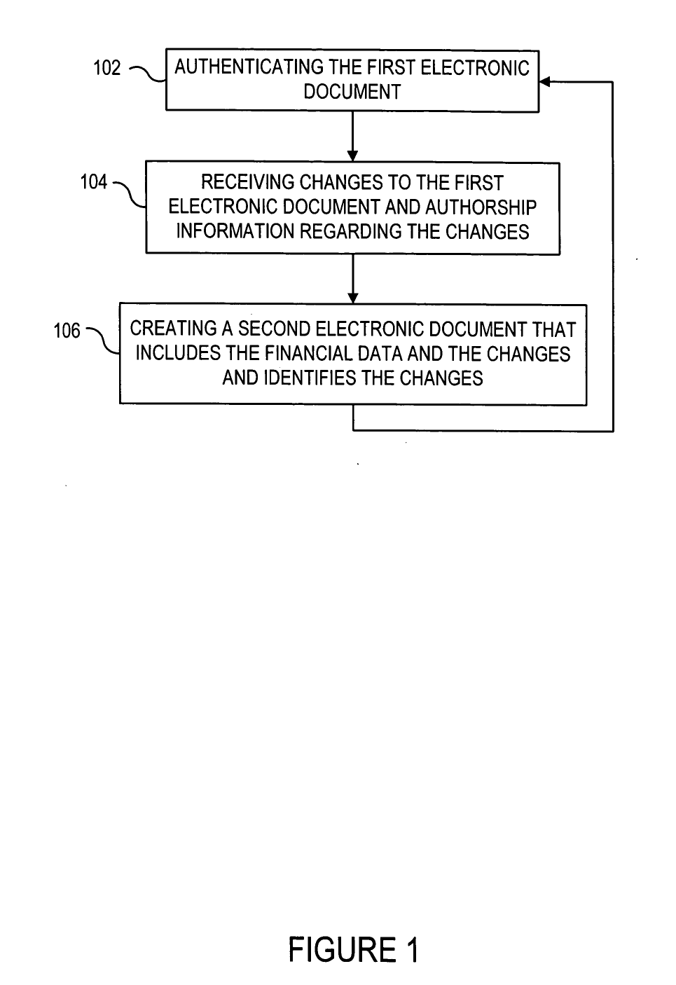

In an exemplary method shown in FIG. 1 for tracking changes to a first electronic document containing financial data, in a first block 102 the first electronic document is authenticated, for example by a local or remote authentication service, based on one or more of a digital signature within or accompanying the first electronic document, by comparing the first electronic document with a securely archived master or verification copy, and so forth. In a next block 104, changes to the first electronic document and authorship information regarding the changes are received, for example by a computer operated or accessed by a user and displaying the first electronic document and/or the financial data. The changes can be authored by the user, and the authorship information can identify the user or the user's organization and/or authority. In a next block 106, a second electronic document that includes the financial data and the changes and identifies the changes, is created, for example an Automatic Audit Trail software application resident on the user's computer and/or resident on a different computer or computing resource and in communication with the user's computer or computing resource containing the first electronic document. From block 106, control can return to block 102, so that additional iterations can be performed, and successive alterations to the document and/or the financial data can be tracked, identified and authenticated. The second electronic document can be for example XBRL-compliant, and can describe the financial data and the changes via XBRL. In an exemplary embodiment, one or both of the first and second documents can include a digital signature, the second document can be stored in a secure archive with restricted access, for example accessible only by authorized parties or entities such as an authentication service, and the authentication service can verify the first document based on the second document, which can be a non-repudiation document.

In accordance with exemplary embodiments, the Automatic Audit Trail software application can be an add-in or plug-in that is compatible with all major spreadsheet software and/or word processors, and in an exemplary method can be provided to customers free of charge. An exemplary embodiment of the software requires the user to be connected to a Web service such as AuthentiDate or any other approved Web based Authentication and Date/Time stamping. AuthentiDate is one system that has been approved by the U.S. Postal Service, and “stamps” electronic documents with an electronic postmark indicating date and time and then archives electronically postmarked files for a period of time (e.g. 7 years) to authenticate content as of the time of the postmark and thereby ensure “trusted non-repudiation of content”.

When the Automatic Audit Trail software application is connected (e.g. via an “on-line” Internet or other network or intranet connection) to an Authentication Service such as a Web Authentication Service, the spreadsheet can show the following authentication information after the first export from the accounting software into the spreadsheet: 1) who exported the data into the spreadsheet, 2) date and time of edit, and 3) iteration or document/data version number. Additional information can be provided, for example, data source information including the name and/or version number, serial number, etc. of the software that provided the data to—or for—the spreadsheet, identification of the financial report version, and so forth. This information can be provided in various ways, including for example with a digital signature, including for example an XMLDigital Signature, in encrypted form, and so forth. Each version of the file or electronic document or collection of data can be linked to the Web Authentication service (e.g. AuthentiDate) in a variety of ways, for example by numbering or otherwise uniquely marking or identifying each XBRL version of the document, and so forth.

In an exemplary embodiment, every amendment/change is tracked and charged to the Automatic Audit Trail software application user on a “pay-per-use” basis.

The Automatic Audit Trail software application and/or the spreadsheet or word processing software can identify incoming data as locked or authentic and therefore changeable only by strict procedure in various ways. In one exemplary method, the following steps are included: When the user (who may, for example, need to comply with a regulator's requirements, e.g. the requirements set forth in Sarbanes-Oxley legislation) is considering to use a spreadsheet to produce his financial statements, he uses a spreadsheet software that includes or works in conjunction with an Automatic Audit Trail software application Add-in, which can be provided online or can interact with the spreadsheet via an Internet or other link, for example. Authentication services such as those provided by an Authentication Web Service such as Authentidate are also provided, separately (e.g. in the manner of Authentidate) or through the Automatic Audit Trail software application. When the user exports the financial data from his accounting software/ERP, the spreadsheet created by this export is automatically authenticated and stored (e.g. with author/source, date and time-stamping information), using the Authentication services. After authentication, this stored non-repudiation document is an initial document e.g. with the “version 000000001”, from which modifications or amendments can be tracked. When the user wants to amend/modify the “initial version” of the appropriate document (for example, as when reading a “protected file” in Excel), the user can make changes under the following conditions: a) identifying the author of the projected amendment (an administration procedure can control or provide this function) and b) when all amendments are completed, the user saves the new version of the file (with all changes having been tracked by the software) and the new version is authenticated and stored in the Web Authenticated service.

Changes can be tracked in many different ways, including but not limited to storing both old and new elements, by storing a comparison or “redlined” version, and so forth.

In an exemplary embodiment, the Automatic Audit Trail software application prevents a user from amending/modifying any cell of the “Authenticated” spreadsheet unless the user is connected to an authentication mechanism, for example connected online to a Web-based Authentication/Date & Time Stamping service (e.g AuthentiDate or similar system). The Automatic Audit Trail software application, separately or in combination with the Spreadsheet software, can a) require the user to identify himself (e.g. for tracking purposes) and b) protect data in the spreadsheet from being modified unless all mechanisms and information necessary to track modifications, are in place and functional. The mechanisms and information can include for example the user's identity, identification of, or connection to, a web-based authentication/time-stamping service (e.g., a Uniform Resource Identifier or “URI”), a public encryption/decryption key of the service, and so forth.

The Automatic Audit Trail software application can utilize the UBmatrix XBRL technology which is based on the UBMatrix patent pending Method for Adding Metadata to data. The Automatic Audit Trail software application can create, from the first export of data into an “Authenticated” spreadsheet, an XBRL Instance Document including Authentication information, as shown for example below. In an exemplary embodiment, the user can select an XBRL Taxonomy of his choice (for example: US GAAP Taxonomy).

An exemplary XBRL Instance Document corresponding to the Rock Castle Construction balance sheet described herein, including authentication information, can take the following form:

| | <?xml version=“1.0” encoding=“utf-8”?> |
|---|---|
| − | <!-- |

Instance Document based on XBRL standard 2.1
Created by UBmatrix Automator Professional Edition
6.300.1649.36405.
Contact www.ubmatrix.com
Software Copyright (c) 2002-2004 Universal Business
Matrix LLC
Authentication: Authentidate - version 2004-01-
www.authentidate.com

| | --> |
|---|---|
| − | <xbrl xmlns=“http://www.xbrl.org/2003/instance” |

xmlns:xlink=“http://www.xbrl.org/2003/linkbase”
xmlns:xlink=“http://www.w3.org/1999/xlink”
xmlns:xsi=http://www.w3.org/2001/XMLSchema-instance
xmlns:iso4217=“http://www.xbrl.org/2003/iso4217”
xmlns:new=“http://www.example.com/new”
xsi:schemaLocation=“http//www.example.com/new
RockCastle.xsd”>
xlink:schemaRef xlink:type=“simple”
xlink:href=“RockCastle.xsd”

/>
−< Authentication id=“rockcastle-2003-12-31BS”>
−<author=“DavidReam”>
−<iteration=0000000001><date=2004-04-10><time=5:01PM-ECT
−<context id=“context-1”>

−<period>
<instant>“2003-12-31 </instant>
</period>

</context>
− <unit id=“unit-1”>

<measure>iso4217:USD</measure>

</unit>
<new:Checking contextRef=“context-1” decimals=“2”>−8416.35
</new:Checking>
<new:Savings contextRef=“context-1” decimals=“2”>14368.42
</new:Savings>
<new:TotalCheckingSavings contextRef=“context-1”
decimals=“2”>5952.07
</new:TotalCheckingSavings>
<new:AccountsReceivableCopy contextRef=“context-1”
decimals=“2”>79320.45
</new:AccountsReceivableCopy>
<new:TotalAccountsReceivable contextRef=“context-1”
decimals=“2”>79320.45
</new:TotalAccountsReceivable>
<new:ToolsEquipment contextRef=“context-1” decimals=“2”>5000
</new:ToolsEquipment>
<new:InventoryAsset contextRef=“context-1”
decimals=“2”>23522.64
</new:InventoryAsset>
<new:Retainage contextRef=“context-1” decimals=“2”>2461.8
</new:Retainage>
<new:UndepositedFunds contextRef=“context-1”
decimals=“2”>36982.34
</new:UndepositedFunds>
<new:TotalOtherCurrentAssets contextRef=“context-1”
decimals=“2”>67966.78
</new:TotalOtherCurrentAssets>
<new:TotalCurrentAssets contextRef=“context-1”
decimals=“2”>153239.3
</new:TotalCurrentAssets>

An exemplary Automated Audit Trail Authentication method using XBRL (or other standard) can be performed using various processes. In an exemplary process, the XBRL or any other standard Instance Document is stamped following each revision of the data in the spreadsheet or the document from the word processor, for example in a fashion similar to the way Authentidate “stamps” an electronic document, or any other technique that provides identification, authentication, time information etc. The resulting document can be, for example, an XBRL non-repudiation document, which can be exported from an Authentication storage/archive for each round of (new) amendments. In another exemplary process, stamping individual context is performed by adding Metadata (for example Scenario Metadata), for example by providing timestamp/revision information as context metadata for elements of data being modified. The context can be XBRL “scenario” context, and can be used to track each amended data element.

Metadata can be added external to the contexts in an XBRL instance document or any other standard Instance Document. “External” metadata can be, for example, additional metadata that is placed near the beginning of an XBRL instance document before context information, and can have an exemplary form including components -<authenticationid=“rockcastle-2003-12-31BS>, -<author=“DavidReam”>, -<iteration=0000000001><date=2004-04-10><time=5:01 PM-ECT>. Identification and/or comment information (e.g., a URI), for example at the beginning of the instance document, can indicate or identify the service that performed the authentication, as well as contact or other information regarding the service, such as a website address, telephone number, postal address, email address, public encryption/decryption key, and so forth.

FIG. 1 illustrates an example where a user “PatrickKeane” amended/modified a spreadsheet to consolidate separate “Checking” and “Savings” entries or categories into a single entry or category “Checking/Savings” spreadsheet. As shown in FIG. 1, the Automatic Audit Trail software can insert information into the spreadsheet such as the author who changed the document, date, time and revision or iteration number.

In an exemplary embodiment an XBRL Instance Document corresponding to the spreadsheet is automatically amended in order to track all changes in the spreadsheet (using the Automatic Audit Trail software application connected to an Authentication On Line Service, for example AuthentiDate). The resulting Instance Document can be amended in real time or at a time when the amended spreadsheet document is saved by the user, for example at the end of a revision session, when the user has completed all revisions. The XBRL Instance Document corresponding to the revision of “PatrickKeane” shown in FIG. 1, can take the following form:

| | <?xml version=“1.0” encoding=“utf-8”?> |
|---|---|
| − | <!-- |

Instance Document based on XBRL standard 2.1
Created by UBmatrix Automator Professional Edition
6.300.1649.36405.
Contact www.ubmatrix.com
Software Copyright (c) 2002-2004 Universal Business
Matrix LLC
Authentication: Authentidate - version 2004-01-
www.authentidate.com

| | --> |
|---|---|
| − | <xbrl xmlns=“http://www.xbrl.org/2003/instance” |

xmlns:xlink=“http://www.xbrl.org/2003/linkbase”
xmlns:xlink=“http://www.w3.org/1999/xlink”
xmlns:xsi=http://www.w3.org/2001/XMLSchema-instance
xmlns:iso4217=“http://www.xbrl.org/2003/iso4217”
xmlns:new=“http://www.example.com/new”
xsi:schemaLocation=“http//www.example.com/new
RockCastle.xsd”>
xlink:schemaRef xlink:type=“simple”
xlink:href=“RockCastle.xsd”

/>
−< Authentication id=“rockcastle-2003-12-31BS”>
−<author=“PatrickKeane”>
−<iteration=0000000002><date=2004-04-11><time=3:15PM-ECT
−<context id=“context-1”>

−<period>

<instant>“2003-12-31 </instant>

</period>

</context>
− <unit id=“unit-1”>

<measure>iso4217:USD</measure>

</unit>
<old:Checking contextRef=“context-1” decimals=“2”>−8416.35
</old:Checking>
<old:Savings contextRef=“context-1” decimals=“2”>14368.42
</ old:Savings>
<new:CheckingSavings contextRef=“context-1”
decimals=“2”>5952.07
</new:CheckingSavings>
<new:TotalCheckingSavings contextRef=“context-1”
decimals=“2”>5952.07
</new:TotalCheckingSavings>
<new:AccountsReceivableCopy contextRef=“context-1”
decimals=“2”>79320.45
</new:AccountsReceivableCopy>
<new:TotalAccountsReceivable contextRef=“context-1”
decimals=“2”>79320.45
</new:TotalAccountsReceivable>
<new:ToolsEquipment contextRef=“context-1” decimals=“2”>5000
</new:ToolsEquipment>
<new:InventoryAsset contextRef=“context-1”
decimals=“2”>23522.64
</new:InventoryAsset>
<new:Retainage contextRef=“context-1” decimals=“2”>2461.8
</new:Retainage>
<new:UndepositedFunds contextRef=“context-1”
decimals=“2”>36982.34
</new:UndepositedFunds>
<new:TotalOtherCurrentAssets contextRef=“context-1”
decimals=“2”>67966.78
</new:TotalOtherCurrentAssets>
<new:TotalCurrentAssets contextRef=“context-1”
decimals=“2”>153239.3
</new:TotalCurrentAssets>

In an exemplary embodiment, the cumulative changes are identified, as well as the authorship of each change. This can, for example, be implemented using XBRL. For example, old information can be marked with the “<old”, “</old” labels or markers, can be arranged by sections or in a sequence reflecting chronology of the changes, and each section of changes can include authorship and/or be otherwise associated with corresponding authorship information. XML digital signatures can, for example, be used to sign or mark each set of changes corresponding to a particular revision, or can be otherwise associated so that each XML signature corresponds to the changes belonging to a particular revision or chronology, and/or author.

In an exemplary embodiment, two documents can be maintained, for example an original spreadsheet, word processing document, or other document containing the financial data, and a corresponding XBRL Instance Document that also contains the data as well as change and authorship information. Additional documents can be associated with the original document, for example multiple XBRL Instance Documents. For example, each XBRL Instance Document can correspond to a single revision, so that multiple XBRL Instance Documents would represent multiple revisions and together would represent a revision history, while the original (modified) document would represent the latest revision. In another exemplary embodiment, only one document is maintained, and includes a cumulative revision history and any desired authentication information, comprising for example the original document with changes and additional data relating to the history and authentication. In an exemplary embodiment, the original document is converted or transformed into an XBRL document, and thereafter only the XBRL document is used to convey the financial information (including any revisions), as well as information identifying the revisions and indicating a revision history, together with any desired authentication information.

In an exemplary embodiment, the Automatic Audit Trail software application can provide a “Revision” report, which can for example include, or be provided in exchange for, a fee due for the tracking and authentication. The fee can for example be calculated for example on a pay-per-use basis, transaction and/or subscription fee to the Automatic Audit Trail software application and the Authentication Web Service, or any other basis.

Exemplary embodiments can include and/or provide the following additional features. An Historical Audit Trail Report that shows all amendments and/or modifications since the initial export of the data into the spreadsheet software (including Author, date and time stamping, accounts and sub-account names and fact values). Access control can be implemented, where for example a degree of access and access privileges depend on roles and entitlements for each corporate user and/or accounting service employee. Automatic Assistance On Line, wherein the Automatic Audit Trail software application user is assisted in several ways while he is amending and/or modifying the financial data in the spreadsheet (for example, while being connected on line to UBmatrix AAT+Authentication services). For example, when the user wants to change any “account” labeling, the Automatic Audit Trail software application will allow the user to use either exclusively any of the “XBRL concepts” listed in the taxonomy used to produce the XBRL instance document or, even, to extend this taxonomy if the user needs to create a new “account” (XBRL concept) that does not currently exist in the taxonomy.

In an exemplary embodiment, the user invokes or starts the Automatic Audit Trail application or functions before or after making revisions, in another embodiment the Automatic Audit Trail application is automatically invoked or launched when the user tries to make or save revisions to an electronic financial document. The electronic financial document can for example include a code or other mechanism that determines whether the Automatic Audit Trail application is automatically or selectively invoked (e.g. by the user), and can indicate different conditions that require or allow automatic or selective invocation. In an exemplary embodiment, the Automatic Audit Trail application automatically or transparently initiates and handles communications with an authentication service or authentication application. In an exemplary embodiment, the Automatic Audit Trail application and an authentication application are integrated, part of the same application, controlled by a common application or user, or are otherwise functionally related. In an exemplary embodiment, the Automatic Audit Trail application can prompt the user to select and/or confirm selection of an authentication application or service. In an exemplary embodiment, submission of a document to an authentication application or service can trigger an automatic or selective (e.g., requested or confirmed by a user) evaluation of the document, and if the document is different from but corresponds to another document archived or available to the authentication application or service, the authentication application or software can (e.g., by invoking the Automatic Audit Trail application or software) prompt the user to confirm identity of the document, and/or provide additional information identifying authorship and/or chronology of detected changes or differences between the documents, confirm the changes, and so forth. In an exemplary embodiment, the Automatic Audit Trail application can compare or contrast different versions of a document, and indicate differences between the versions as well as authorship, chronology, etc. of the detected differences, and can flag or otherwise provide an alert with respect to specific differences or types of differences. For example, changes by a specified author can be flagged, and changes that are inconsistent or indicate some kind of discrepancy (e.g., mismatching chronologies) or prohibited change can also be flagged.

An exemplary method includes receiving financial data, authenticating the data or creating a non-repudiation document comprising the data, tracking changes to the data in the non-repudiation document, and creating a new non-repudiation document that includes and identifies the tracked changes.

The methods, logics, techniques and pseudocode sequences described herein can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Exemplary methods and processes described herein can be embodied in software or computer program(s) stored on a machine-readable medium, wherein the software or computer program(s) includes instructions for causing a computing device such as a computer, computer system, microprocessor, or other computing device, to perform the methods or processes. For example, in exemplary embodiments the authentication software, the audit trail software and software a user employs to view and/or alter a financial document, as well as archival/storage resources, can be located on different computers connected by intra-network and/or inter-network links including links through the Internet. Alternatively the software and associated hardware and/or archival storage resources can be variously co-located in whole or in part (all on one machine or network, some co-located on one machine or network with the other(s) located on a different machine or network), and each software or hardware resource (including hardware processor and/or hardware archival/storage resources) can also be variously distributed among different locations, networks, and so forth.

1. A method for tracking changes to a first electronic document containing financial data, comprising:
authenticating the first electronic document;
receiving changes to the first electronic document and authorship information regarding the changes;
creating a second electronic document that includes the financial data and the changes and identifies the changes.

2. The method of claim 1, comprising:
repeating the authenticating, receiving and creating.

3. The method of claim 2, wherein the second electronic document identifies cumulative changes and the author of each change.

4. The method of claim 1, wherein the second electronic document is XBRL-compliant.

5. The method of claim 4, wherein the second electronic document describes the data and the changes via XBRL.

6. The method of claim 1, comprising:
receiving payment from a user wherein the payment is based on the second electronic document.

7. The method of claim 1, wherein the first electronic document includes a digital signature.

8. The method of claim 1, wherein the second electronic document includes a digital signature.

9. The method of claim 1, comprising:
storing the second electronic document in a secure archive accessible by an authentication service.

10. The method of claim 1, comprising:
verifying the first electronic document based on the second electronic document.

11. The method of claim 1, wherein the second electronic document is a non-repudiation document.

12. The method of claim 1, wherein the second electronic document forms a new first electronic document.
